(19) United States
(12) Patent Application Publication
(10) Pub. No.: US 2011/0001691 A1
(43) Pub. Date: Jan. 6, 2011

(54) LIQUID CRYSTAL DISPLAY DEVICE

(76) Inventors: Yoshito Hashimoto, Osaka (JP); Hiroyuki Ohgami, Osaka (JP); Masakazu Shibasaki, Osaka (JP); Masumi Kubo, Osaka (JP); Masayuki Soga, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/864,311

(22) PCT Filed: Jan. 20, 2009
(86) PCT No.: PCT/JP2009/000168

§ 371 Date: Jul. 23, 2010

(30) Foreign Application Priority Data
Jan. 25, 2008 (JP) 2008-015646

(51) Int. Cl. G09G 3/36

(52) U.S. Cl. 345/87

(57) ABSTRACT

A pixel of a liquid crystal display device of the present invention includes a liquid crystal layer 42, a pixel electrode 12 and a counter electrode 22 opposing each other via the liquid crystal layer, a pair of vertical alignment films 32a, 32b, and alignment sustaining layers 34a, 34b formed by a photopolymerized material on surfaces of the alignment films which are closer to the liquid crystal layer. The pixel electrode has cruciform trunk portions 12h, 12v which are positioned so as to coincide with polarization axes of the pair of polarizing plates and a plurality of branch portions 12a, 12b, 12c, and 12d extending from the cruciform trunk portions in directions of approximately 45°. The counter electrode has a cruciform opening 22a which is positioned so as to oppose the cruciform trunk portions. When a predetermined voltage is applied across the liquid crystal layer, four liquid crystal domains are formed. The pretilt azimuth of a liquid crystal molecule included in a region corresponding to each of the four liquid crystal domains is regulated by the alignment sustaining layers.

### TECHNICAL FIELD

The present invention relates to a liquid crystal display device and specifically to an alignment control structure preferably applied to a liquid crystal display device which has a relatively small pixel pitch.

BACKGROUND ART

Recently, as liquid crystal display devices which have wide viewing angle characteristics, transverse electric field mode devices (including IPS mode devices and FFS mode devices) and vertical alignment (VA) mode devices are used. The VA mode devices are superior to the transverse electric field mode devices in terms of mass production and therefore have been used in a wide variety of TV applications and mobile applications.

The VA mode liquid crystal display devices are generally classified into MVA mode devices (see Patent Document 1) and CPA mode devices (see Patent Document 2).

In the MVA mode devices, alignment control means (slit or rib) which has linear portions extending in two directions perpendicular to each other is provided to form four liquid crystal domains between the alignment control means such that the azimuthal angles of the directors which are representative of the respective domains form angles of 45° relative to the polarization axes (transmission axes) of polarizing plates placed in crossed Nicols. Assuming that the azimuthal angle of 0° is identical with the 3 o'clock direction of the clock dial and that the counterclockwise direction is the positive direction, the azimuthal angles of the directors of the four domains are 45°, 135°, 225°, and 315°. This configuration is most preferable in terms of transmittance because linear polarization in the 45° direction relative to the polarization axes is not absorbed by the polarizing plates. Such a configuration in which four domains are formed in one pixel is referred to as “4-domain alignment structure” or simply “4D structure”.

However, the above-described MVA mode is not suitable to small pixels (for example, the shorter side is less than 100 μm, specifically less than 60 μm). For example, when a slit is used as the alignment control means, the width of the slit need to be about 10 μm or more in order to produce a sufficient anchoring force. To form four domains, it is necessary to form in a counter electrode a slit including portions extending in directions which are different from each other by 90° when viewed in a direction normal to the substrate (“<”-shaped slit) and to form two “<”-shaped slits in a pixel electrode such that the two slits are disposed parallel to each other with a certain space therebetween relative to the counter electrode slit that is assumed as the center. Specifically, it is necessary to dispose the sets of three slits each having the width of about 10 μm so as to be in parallel to each other and to extend in the 45°-225° direction and the 135°-315° direction. If this configuration is applied to a pixel with the shorter side being less than 100 μm, the transmittance (luminance) greatly deteriorates because part of the pixel in which the slits (or ribs) are provided does not contribute to the display. In a small-size liquid crystal display device with higher resolution, for example, a 2.4-inch VGA device for use in mobile phones, the pitch of the pixels (row direction×column direction) is, for example, 25.5 μm×76.5 μm. In such small pixels, even formation of the above-described slit is impossible. As a matter of course, if the width of the slit is decreased, a sufficient anchoring force cannot be obtained.

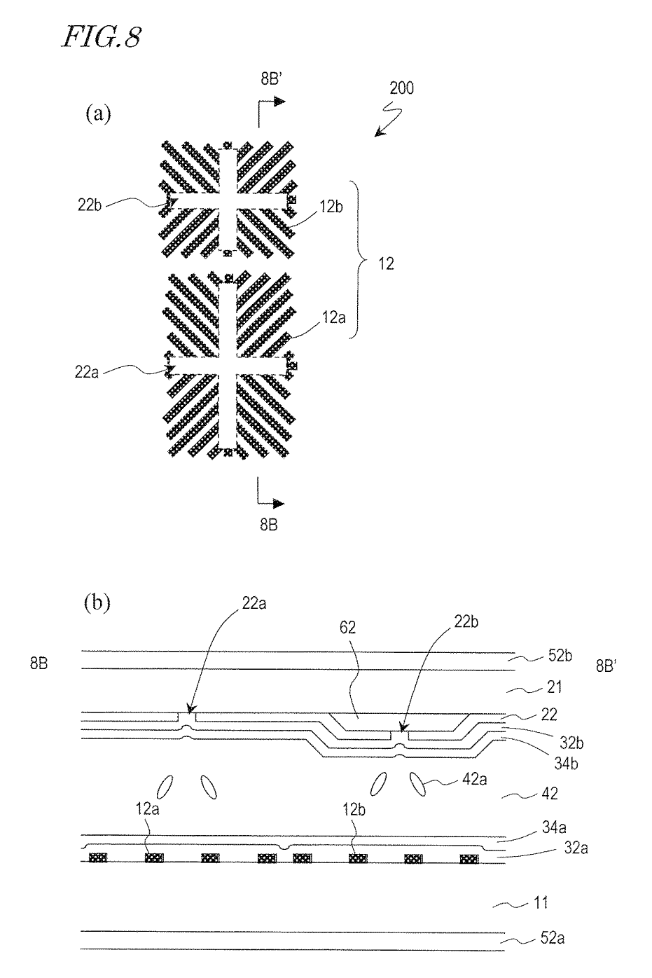

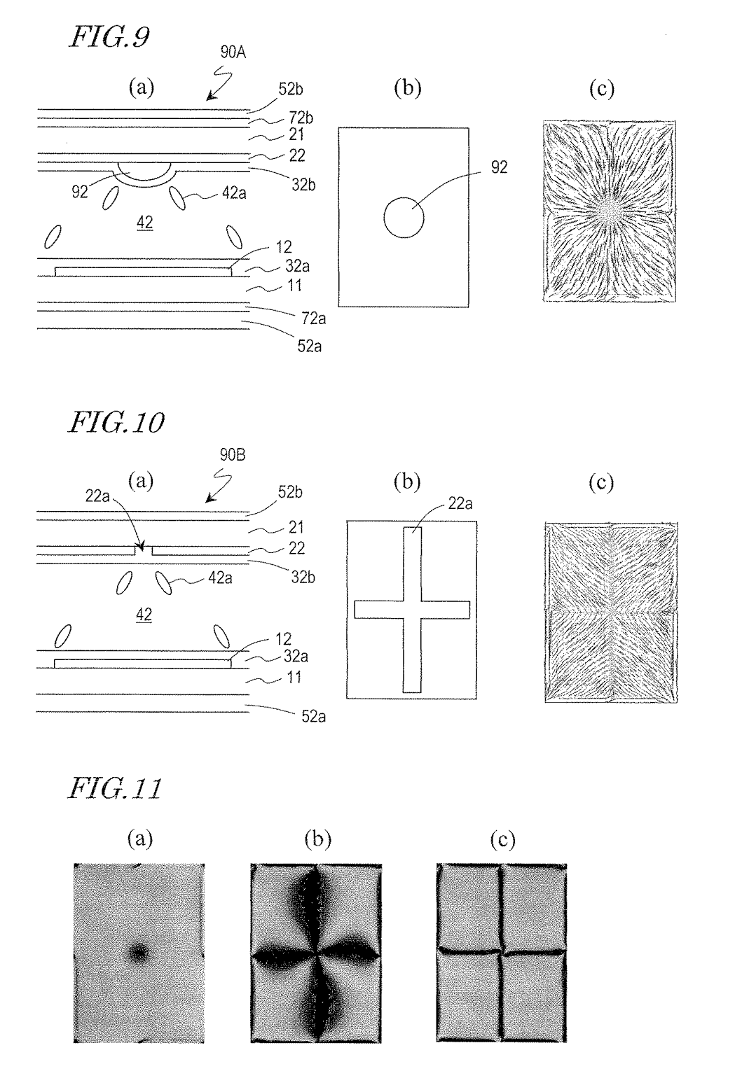

Because of the above circumstances, liquid crystal display devices with relatively small pixels employ the CPA mode. A structure of a CPA mode liquid crystal display device is briefly described with reference to FIGS. 9(a) to 9(c).

FIG. 9(a) is a schematic cross-sectional view of one pixel of a CPA mode liquid crystal display device 90A. FIG. 9(b) is a schematic plan view of the pixel. FIG. 9(a) shows the alignment of liquid crystal molecules 42a in an intermediate gray scale level display state. FIG. 9(c) is a plan view schematically showing the alignment of the liquid crystal molecules in a white display state. Note that, in the drawings mentioned below, like elements are designated by like reference numerals, and the description thereof is sometimes omitted.

The liquid crystal display device 90A includes a vertical alignment type liquid crystal layer 42 between a pair of substrates 11 and 21. The liquid crystal layer 42 is alignment-controlled by vertical alignment films 32a and 32b. The liquid crystal molecules 42a have negative dielectric anisotropy. The azimuths in which the liquid crystal molecules 42a are inclined in the presence of an applied voltage are regulated by an oblique electric field generated at an edge portion of a pixel electrode 12 and an anchoring force of a rivet (protrusion) 92 provided on a side of a counter electrode 22 which is closer to the liquid crystal layer 42. Application of a sufficiently high voltage leads to an alignment in which the liquid crystal molecules 42a are radially inclined around the rivet 92 as shown in FIG. 9(c). In this case, the alignment of the liquid crystal molecules 42a has axial symmetry (C_{∞}) about the rivet 92. A domain which results in such an alignment is referred to as a “radially-inclined alignment domain” or “axially symmetric alignment domain”.

The liquid crystal display device 90A includes a pair of polarizing plates 52a and 52b which are disposed so as to oppose each other via the liquid crystal layer 42. The liquid crystal display device 90A includes ¼-wave plates (quarter-wave plates) 72a and 72b which are respectively disposed between the polarizing plates 52a and 52b and the liquid crystal layer 42. The polarizing plates 52a and 52b are disposed such that their polarization axes are perpendicular to each other (crossed Nicols arrangement). By utilizing an omniazimuthal, radially inclined alignment domain and circular polarization, high transmittance (luminance) can be achieved. FIG. 11(a) shows a simulation result of the distribution of transmittance in a pixel in a white (highest gray scale level) display state of the liquid crystal display device 90A. The result shows high transmittance uniformly achieved in the pixel except for a low transmittance region near the center of the rivet 92.

The CPA mode which uses ¼-wave plates achieves high transmittance but has the problems of low contrast ratio and narrow viewing angle as compared with the MVA mode. Specifically, when ¼-wave plates are used, a phenomenon where a state of display (especially, a state of display at a low gray scale level (low luminance)) which is perceived as being brighter when viewed at an oblique viewing angle than when viewed from a position in front of the display device (in a direction normal to the display surface, viewing angle 0°), so-called “whitening”, is more conspicuous than in the MVA mode.

By omitting the ¼-wave plates 72a and 72b of the liquid crystal display device 90A, i.e., by combining the CPA mode and linear polarization, whitening is prevented, the contrast ratio is improved, and the viewing angle can be increased. However, the transmittance decreases as shown in FIG. 11(b). FIG. 11(b) shows a simulation result of the distribution of transmittance in a pixel in a white display state of a modification of the liquid crystal display device 90A from which the ¼-wave plates 72a and 72b are omitted. The result shows very low transmittance in a region where the orientations of the liquid crystal molecules are parallel to the absorption axes of the polarizing plates.

Patent Document 3 discloses that providing a cruciform slit in a counter electrode enables formation of four domains (FIG. 8, paragraph <0033>). A structure of a VA-mode liquid crystal display device 90B to which the structure of Patent Document 3 is applied is briefly described with reference to FIGS. 10(a) to 10(c). FIG. 10(a) is a schematic cross-sectional view of one pixel of the liquid crystal display device 90B. FIG. 10(b) is a schematic plan view of the pixel. FIG. 10(c) is a plan view schematically showing the alignment of the liquid crystal molecules in a white display state.

In the liquid crystal display device 90B, in the presence of an applied voltage, the azimuths in which the liquid crystal molecules 42a are inclined are regulated by an oblique electric field generated at an edge portion of the pixel electrode 12 and an oblique electric field generated near a slit (or “opening”) 22a of a counter electrode 22. When the voltage applied across the liquid crystal layer 42 is sufficiently high, four domains are formed as shown in FIG. 10(c). Assuming that the horizontal slit of the cruciform opening 22a shown in FIG. 10(b) is identical with the X-axis and the vertical slit is identical with the Y-axis, the azimuthal angles of the directors of the respective domains formed in the first, second, third, and fourth quadrants of the pixel are 45°, 135°, 225°, and 315°. Therefore, the distribution of transmittance in a pixel in a white (highest gray scale level) display state of the liquid crystal display device 90B exhibits uniform high transmittance except for regions which are parallel to the absorption axes of the polarizing plates as shown in FIG. 11(c).

However, in the liquid crystal display device 90B, an anchoring force occurs only when a voltage is applied, whereas the rivet 92 of the liquid crystal display device 90A produces an anchoring force irrespective of the presence or absence of an electric field. Therefore, when the applied voltage is low, a sufficient anchoring force is not produced. Thus, the alignment of the liquid crystal molecules is unstable especially at gray scale levels lower than intermediate gray scale levels. Because of this problem, the liquid crystal display device 90B has not been put to practical use.

On the other hand, a technology called “Polymer Sustained Alignment Technology” (sometimes referred to as “PSA technology”) has been developed for the purpose of improving the response characteristics of the MVA mode (see, for example, Patent Documents 4, 5, and 6). In the PSA technology, alignment sustaining layers (“polymer layers”) are formed by polymerizing, after assemblage of a liquid crystal cell, photopolymerizable monomers contained in prepared liquid crystal material while applying a voltage across the liquid crystal layer, and the resultant alignment sustaining layers are used to cause the liquid crystal molecules to have a pretilt. The pretilt azimuths (the azimuthal angles in the substrate plane) and the pretilt angles (the elevation angles relative to the substrate plane) of the liquid crystal molecules can be controlled by adjusting the distribution and intensity of an electric field applied during the polymerization of the monomers.

Patent Documents 5 and 6 also disclose a structure which employs a pixel electrode with a fine stripe pattern in combination with the PSA technology. When a voltage is applied across the liquid crystal layer, liquid crystal molecules are aligned parallel to the longitudinal direction of the stripe pattern. This alignment contrasts with the conventional MVA mode described in Patent Document 1 in which liquid crystal molecules are aligned in a direction perpendicular to a linear alignment control structure, such as an electrode slit or rib. The line-and-space (L/S) of the fine stripe pattern is, for example, 3 μm/3 μm. This pattern is advantageous in that it can more readily be applied to small size pixels than the conventional MVA mode liquid crystal display devices.

Patent Document 1: Japanese Laid-Open Patent Publication No. H11-242225

Patent Document 2: Japanese Laid-Open Patent Publication No. 2002-202511

Patent Document 3: Japanese Laid-Open Patent Publication No. H06-43461

Patent Document 4: Japanese Laid-Open Patent Publication No. 2002-357830

Patent Document 5: Japanese Laid-Open Patent Publication No. 2003-149647

Patent Document 6: Japanese Laid-Open Patent Publication No. 2006-78968

### DISCLOSURE OF INVENTION

### Problems To Be Solved by the Invention

The present inventor conducted researches and found the disadvantage that, when a structure described in Patent Documents 4 to 6 which employs a pixel electrode with a fine stripe pattern in combination with the PSA technology is applied to a liquid crystal display device which has relatively small pixels (for example, the shorter side is less than 100 μm, particularly less than 60 μm), a large loss luminance is incurred.

The present invention was conceived in order to solve the above problems. One of the objects of the present invention is to improve the luminance of a MVA mode liquid crystal display device which includes a pixel electrode with a fine stripe pattern.

### Means for Solving the Problems

A liquid crystal display device of the present invention includes a plurality of pixels and a pair of polarizing plates placed in crossed Nicols, the liquid crystal display device being configured to display an image in a normally black mode, wherein each of the plurality of pixels includes a liquid crystal layer including a nematic liquid crystal material whose dielectric anisotropy is negative, a pixel electrode and a counter electrode opposing each other via the liquid crystal layer, a pair of vertical alignment films respectively interposed between the pixel electrode and the liquid crystal layer and between the counter electrode and the liquid crystal layer, and a pair of alignment sustaining layers formed by a photopolymerized material on respective surfaces of the pair of alignment films which are closer to the liquid crystal layer, the pixel electrode has at least one cruciform trunk portion which is positioned so as to coincide with polarization axes of the pair of polarizing plates and a plurality of branch portions extending from the at least one cruciform trunk portion in a direction of approximately 45°, the counter electrode has at least one cruciform opening which is positioned so as to oppose the at least one cruciform trunk portion, when a predetermined voltage is applied across the liquid crystal layer, four liquid crystal domains are formed in the liquid crystal layer, azimuths of four directors that are representative of orientations of liquid crystal molecules included in the four liquid crystal domains being different from one another, and each of the azimuths of the four directors being generally parallel to any of the plurality of branch portions, and when no voltage is applied across the liquid crystal layer, a pretilt azimuth of a liquid crystal molecule included in a region corresponding to each of the four liquid crystal domains is regulated by the alignment sustaining layers.

In one embodiment, a width of the at least one cruciform opening is greater than a width of part of the trunk portion to which the opening opposes.

In one embodiment, the four liquid crystal domains include a first liquid crystal domain where an azimuth of a director is a first azimuth, a second liquid crystal domain where an azimuth of a director is a second azimuth, a third liquid crystal domain where an azimuth of a director is a third azimuth, and a fourth liquid crystal domain where an azimuth of a director is a fourth azimuth, a difference between any two of the first azimuth, the second azimuth, the third azimuth, and the fourth azimuth being generally equal to an integral multiple of 90°, and azimuths of directors of liquid crystal domains which are adjacent to each other via one of the at least one cruciform trunk portion are different by about 90°. For example, assuming that the azimuthal angle of a horizontal direction in the display surface is 0°, the first azimuth is about 225°, the second azimuth is about 315°, the third azimuth is about 45°, and the fourth azimuth is about 135°.

In one embodiment, the plurality of branch portions include a first group of a plurality of first branch portions which are parallel to the first azimuth and which are arranged in a stripe pattern, a second group of a plurality of second branch portions which are parallel to the second azimuth and which are arranged in a stripe pattern, a third group of a plurality of third branch portions which are parallel to the third azimuth and which are arranged in a stripe pattern, and a fourth group of a plurality of fourth branch portions which are parallel to the fourth azimuth and which are arranged in a stripe pattern, and in each of the first, second, third, and fourth groups, both a width of each of the plurality of branch portions (L) and a width of a space between any pair of adjacent branch portions (S) are in the range of not less than 1.5 μm and not more than 5.0 μm.

In one embodiment, the pixel electrode includes a plurality of subpixel electrodes aligned in a line along a certain direction, the at least one cruciform trunk portion includes a cruciform trunk portion of each of the plurality of subpixel electrodes, the at least one cruciform opening of the counter electrode includes an opening which is positioned so as to oppose the cruciform trunk portion of each of the plurality of subpixel electrodes, and when a predetermined voltage is applied across the liquid crystal layer, the four liquid crystal domains are formed in each of a plurality of subpixel regions corresponding to the plurality of subpixel electrodes on a one-to-one basis.

In one embodiment, the plurality of subpixel regions include a transmission subpixel region which performs display in a transmission mode and a reflection subpixel region which performs display in a reflection mode.

In one embodiment, the liquid crystal display device further includes an internal retarder selectively provided only in a region corresponding to the reflection subpixel region.

In one embodiment, the photopolymerized material includes a polymerized material of any of a diacrylate monomer or a dimethacrylate monomer, and the liquid crystal layer includes the monomer.

In one embodiment, the pair of alignment sustaining layers include a particle of the photopolymerized material which has a particle diameter of 50 nm or less.

### Effects of the Invention

In a liquid crystal display device of the present invention, a pixel electrode with a fine stripe pattern and a cruciform opening (slit) provided in a counter electrode are utilized to form a 4-domain alignment structure, and alignment sustaining layers regulate the pretilt azimuth of the liquid crystal molecules in each domain. Thus, since the 4D structure and linear polarization are combined, the contrast ratio and the viewing angle characteristics are excellent as compared with the combination of CPA and circular polarization, the transmittance is high as compared with the combination of CPA and linear polarization, and the alignment of the liquid crystal molecules is stable even at low gray scale levels. Further, the luminance can be improved by positioning the cruciform opening so as to extend over a cruciform skeleton portion of the fine stripe pattern.

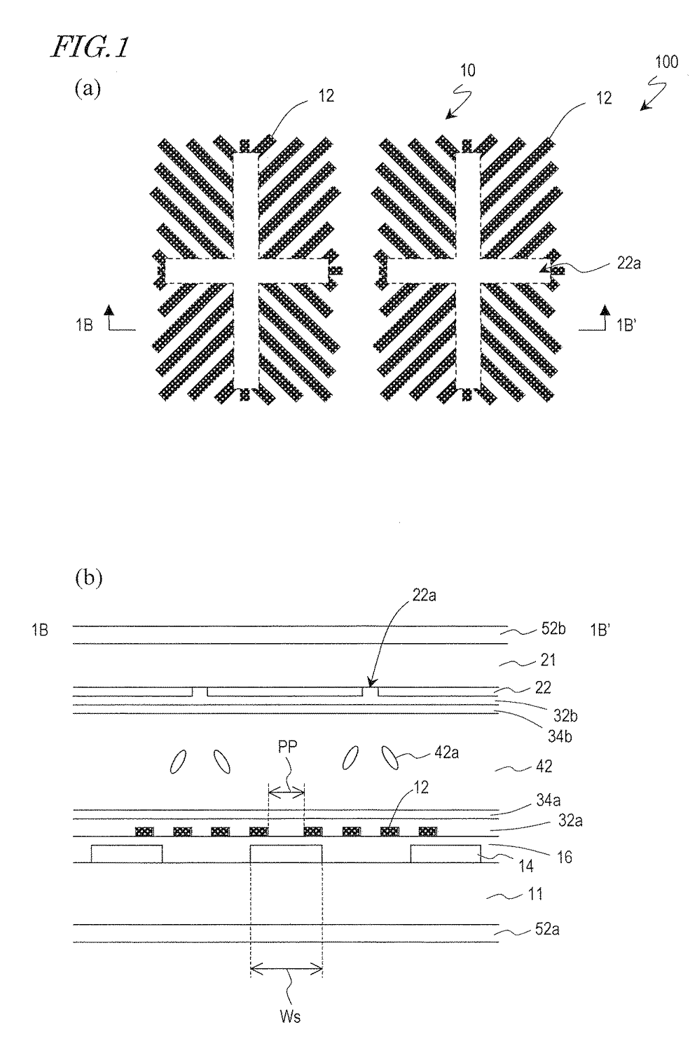

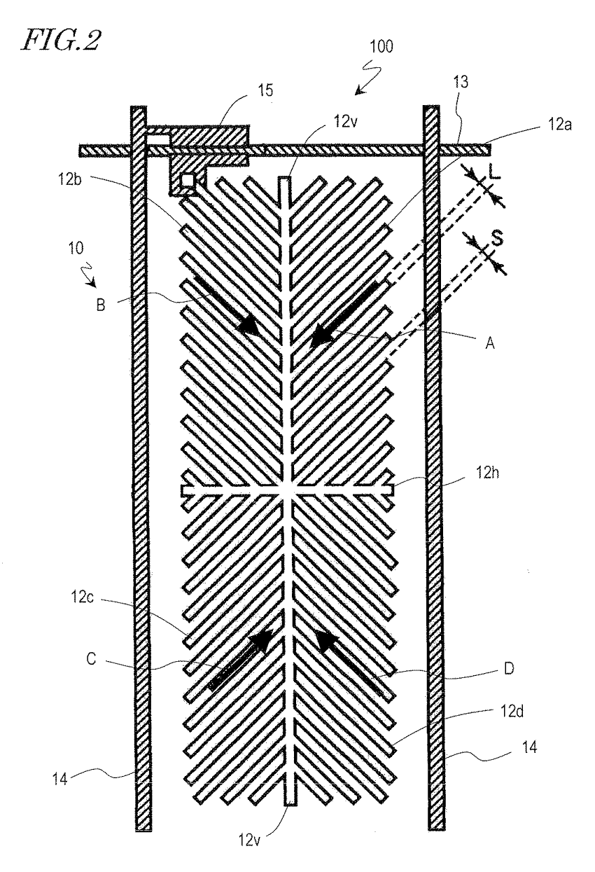

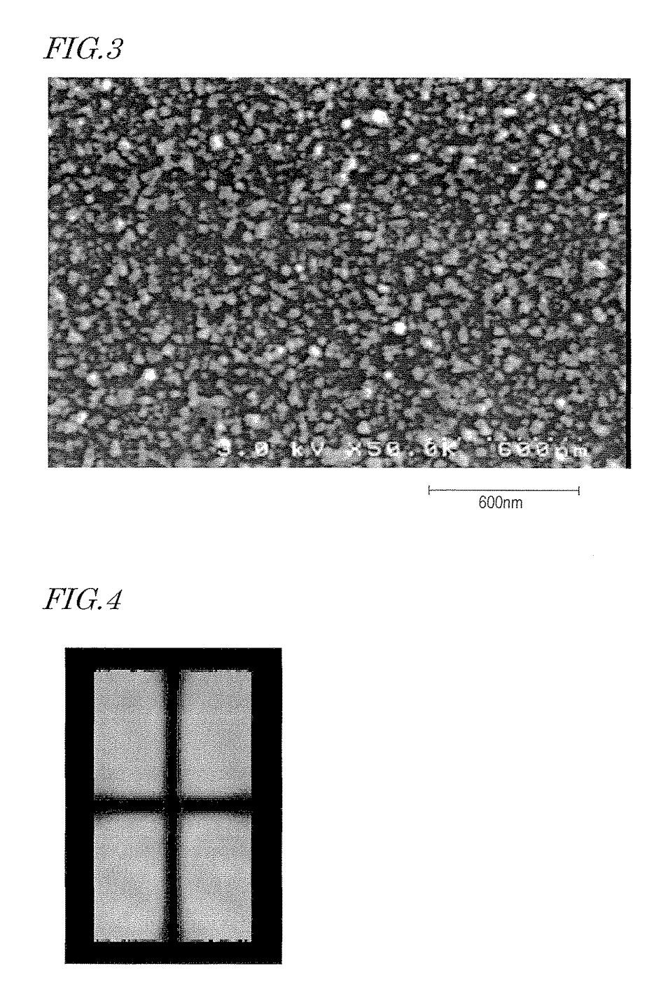

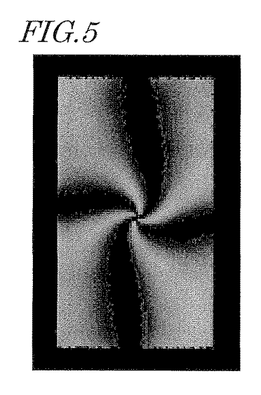

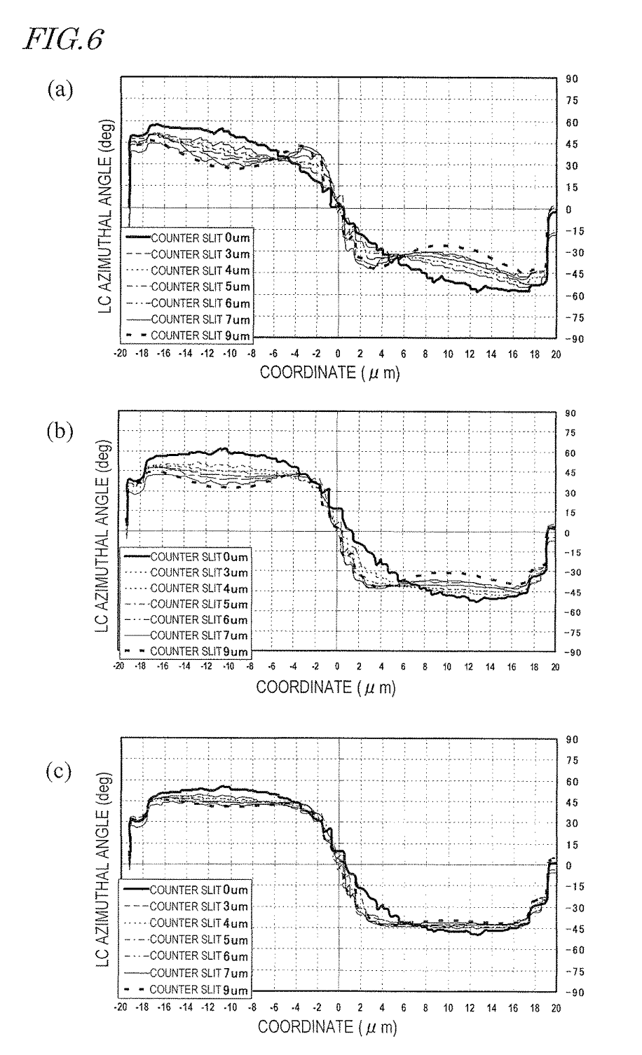

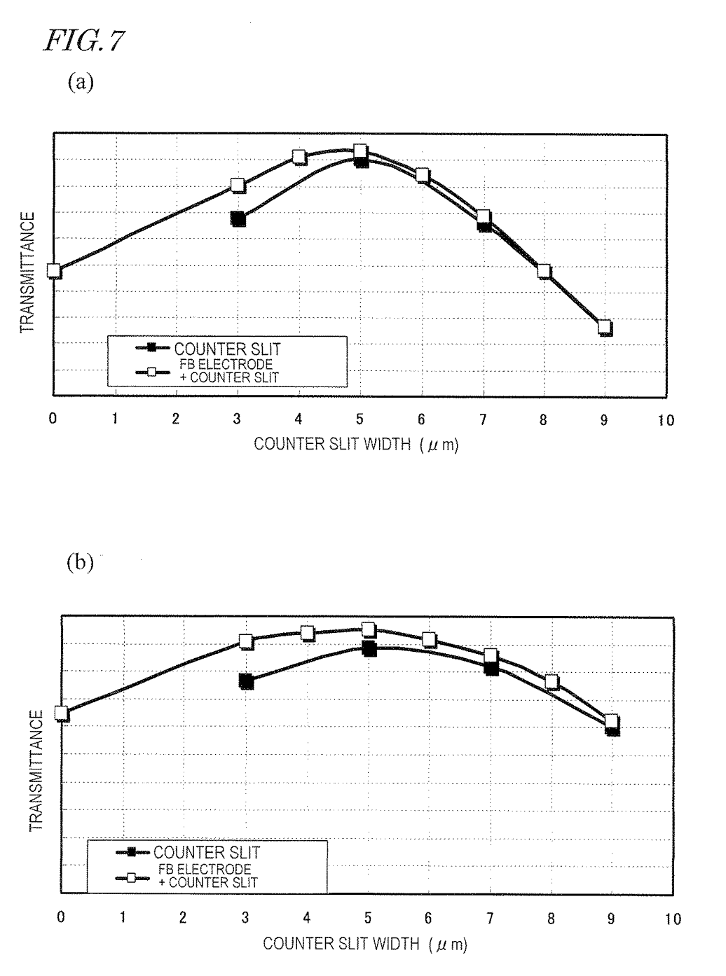

### BRIEF DESCRIPTION OF DRAWINGS

[FIG. 1] Diagrams schematically showing a structure of two pixels of a liquid crystal display device 100 of an embodiment of the present invention. (a) is a plan view. (b) is a schematic cross-sectional view taken along line 1B-1B′ of (a).

[FIG. 2] A plan view for illustrating a structure of a pixel 10 of the liquid crystal display device 100.

[FIG. 3] A SEM image of an alignment sustaining layer included in the liquid crystal display device 100.

[FIG. 4] A simulation result of the distribution of transmittance in a pixel in a white display state of the liquid crystal display device 100.

[FIG. 5] A simulation result of the distribution of transmittance in a pixel in a white display state of a comparative example liquid crystal display device.

[FIG. 6] Graphs showing the distributions of the azimuths of the orientations of liquid crystal molecules with different widths of an opening 22a. (a) shows the distributions during application of 2.5 V across a liquid crystal layer (intermediate gray scale level display state). (b) shows the distributions during application of 4.5 V across a liquid crystal layer (white display state). (c) shows the distributions during application of 10 V which is higher than the white voltage.

[FIG. 7] Graphs showing the relationship between the slit width and the transmittance. The abscissa axis represents the slit width. The ordinate axis represents the transmittance. (a) shows the relationship during application of 4.5 V across a liquid crystal layer (white display state). (b) shows the relationship during application of 10 V which is higher than the white voltage.

[FIG. 8]. Diagrams schematically showing a structure of a pixel of a transflective type liquid crystal display device 200 of an embodiment of the present invention. (a) is a plan view. (b) is a schematic cross-sectional view taken along line 8B-8B′ of (a).

[FIG. 9] (a) to (c) are diagrams showing a structure of a CPA mode liquid crystal display device 90A. (a) is a schematic cross-sectional view of one pixel. (b) is a schematic plan view. (c) is a plan view schematically showing the alignment of liquid crystal molecules in a white display state.

[FIG. 10] (a) to (c) are diagrams for briefly illustrating a structure of a VA mode liquid crystal display device 90B to which a structure of Patent Document 3 is applied. (a) is a schematic cross-sectional view of one pixel. (b) is a schematic plan view. (c) is a plan view schematically showing the alignment of liquid crystal molecules in a white display state.

[FIG. 11] (a) shows a simulation result of the distribution of transmittance in a pixel in a white display state of the liquid crystal display device 90A. (b) shows a simulation result of the distribution of transmittance in a pixel in a white display state of a modification of the liquid crystal display device 90A from which ¼-wave plates 72a and 72b are omitted. (c) shows a simulation result of the distribution of transmittance in a pixel in a white display state of the liquid crystal display device 90B.

### DESCRIPTION OF THE REFERENCE NUMERALS

11, 21 substrate
12 pixel electrode
12a, 12b, 12c, 12d branch portion
12h, 12v trunk portion
22 counter electrode
22a cruciform opening (slit)
32a, 32b vertical alignment film
34a, 34b alignment sustaining layer
42 liquid crystal layer
42a liquid crystal molecules
52a, 52b polarizing plate
100, 200 liquid crystal display device

### BEST MODE FOR CARRYING OUT THE INVENTION

Hereinafter, a structure and operation of a liquid crystal display device of an embodiment of the present invention are described with reference to the drawings. Note that the present invention is not limited to the embodiment described below.

FIG. 1 schematically shows a structure of two pixels 10 of a liquid crystal display device 100 of an embodiment of the present invention. FIG. 1(a) is a plan view. FIG. 1(b) is a cross-sectional view taken along line 1B-1B′ of FIG. 1(a).

The liquid crystal display device 100 has a plurality of pixels and includes a pair of substrates 11 and 21 and a pair of polarizing plates 52a and 52b placed in crossed Nicols on the outer sides of the substrates 11 and 21. The liquid crystal display device 100 is configured to display images in a normally black mode. Each pixel has a liquid crystal layer 42 including a nematic liquid crystal material (liquid crystal molecules 42a) whose dielectric anisotropy is negative, and a pixel electrode 12 and a counter electrode 22 which oppose each other via the liquid crystal layer 42. The pixel electrode 12 has a fine stripe pattern. The counter electrode 22 has a cruciform opening 22a. A pair of vertical alignment films 32a and 32b are respectively provided between the pixel electrode 12 and the liquid crystal layer 42 and between the counter electrode 22 and the liquid crystal layer 42. Surfaces of the alignment films 32a and 32b which are closer to the liquid crystal layer 42 are respectively provided with a pair of alignment sustaining layers 34a and 34b which are formed by a photopolymerized material.

As will be described later in details, the alignment sustaining layers 34a and 34b are formed by, after formation of a liquid crystal cell, polymerizing a photopolymerizable monomer contained in a prepared liquid crystal material while applying a voltage across the liquid crystal layer 42. Before the polymerization of the monomer, the alignment of the liquid crystal molecules 42a is controlled by the vertical alignment films 32a and 32b. When a sufficiently high voltage (e.g., white display voltage) is applied across the liquid crystal layer 42, an oblique electric field generated at an edge portion of the fine stripe pattern of the pixel electrode 12 and an oblique electric field generated near an opening 22a of the counter electrode 22 form a 4D structure. The alignment sustaining layers 34a and 34b function to sustain (memorize) an alignment of the liquid crystal molecules 42a which occurs in the presence of an applied voltage across the liquid crystal layer 42 even after removal of the voltage (in the absence of an applied voltage). Therefore, the pretilt azimuths of the liquid crystal molecules 42a which are regulated by the alignment sustaining layers 34a and 34b (the tilt azimuths of the liquid crystal molecules in the absence of an applied voltage) conform to the azimuths of the directors of the domains of the 4D structure which is formed in the presence of an applied voltage.

The pixel electrode 12 includes a cruciform trunk portion which is positioned so as to coincide with the polarization axes of the pair of polarizing plates 52a and 52b, and a plurality of branch portions extending from the cruciform trunk portion in directions of approximately 45° (see FIG. 2). Here, the polarization axis of one of the polarizing plates 52a and 52b extends in a horizontal direction, and the polarization axis of the other extends in a vertical direction. The trunk portion of the pixel electrode 12 has a cruciform shape in which a linear portion extending in a horizontal direction (12h in FIG. 2) and a linear portion extending in a vertical direction (12v in FIG. 2) intersect with each other near the center. The pixel electrode having such a fine stripe pattern causes the liquid crystal molecules 42a of the liquid crystal layer 42 to incline in an azimuth parallel to a direction in which the branch portions arranged in a stripe pattern extend as described in Patent Documents 5 and 6.

The counter electrode 22 has at least one opening 22a. Here, each pixel has one opening 22a. The opening 22a has a cruciform shape and is positioned so as to oppose the cruciform trunk portion of the pixel electrode 12. Therefore, the cruciform opening 22a is also positioned so as coincide with the polarization axes of the pair of polarizing plates 52a and 52b as the cruciform trunk portion of the pixel electrode 12 is. Note that the cruciform opening 22a provided in the counter electrode 22 is preferably configured such that, when viewed in a direction normal to the substrate, an end of the opening 22a is substantially coincident with an edge of the pixel electrode as shown in FIG. 1(a). This is for the purpose of generating oblique electric fields throughout the liquid crystal layer 42 in the pixel. The end of the opening 22a may extend beyond the edge of the pixel electrode 12. However, if the distance from an opening 22a corresponding to an adjacent pixel electrode 12 is excessively decreased, the resistance value of the counter electrode 22 undesirably increases.

Next, the structure of the pixel 10 of the liquid crystal display device 100 is described in more details with reference to FIG. 2. Note that FIG. 2 shows the structure of a TFT substrate of the liquid crystal display device 100 (including the substrate 11 and the components provided thereon as shown in FIG. 1(b)), in which the counter substrate (including the substrate 21 and the components provided thereon as shown in FIG. 1(b)), the liquid crystal layer 42, etc., are not shown.

As shown in FIG. 2, the TFT substrate includes a glass substrate (reference numeral 11 in FIG. 1), and a gate bus line (scan line) 13, a source bus line (signal line) 14, and a TFT 15 which are provided on the glass substrate. The pixel electrode 12 (see FIG. 1) is provided on an interlayer insulating film 16 (see FIG. 1) that covers the gate bus line 13, the source bus line 14, and the TFT 15. The TFT 15 is ON/OFF-controlled according to a scan signal supplied to the gate bus line 13. When the TFT 15 is ON, a display signal is supplied from the source bus line 14 to the pixel electrode 12. Providing the interlayer insulating film 16 formed of a transparent organic resin enables an edge portion of the pixel electrode 12 to be placed in the vicinity of the source bus line 14, or to extend over the source bus line 14 as shown in FIG. 1, so that the pixel aperture ratio can be improved. For example, the space between pixel electrodes 12 which are adjacent in a row direction, PP, may be 5 μm, and the width of the source bus line 14, Ws, may be 6 μm (see FIG. 1(b)).

The pixel electrode 12 includes a cruciform trunk portion and a plurality of branch portions extending from the cruciform trunk portion in directions of approximately 45°. The cruciform trunk portion has a linear portion 12h extending in a horizontal direction and a linear portion 12v extending in a vertical direction. The horizontal linear portion 12h and the vertical linear portion 12v intersect with each other at the center of the pixel electrode 12. From this trunk portion, the plurality of branch portions extend in directions of approximately 45°. Such a pattern is sometimes referred to as “fishbone shape (FB shape)”.

The plurality of branch portions are divided into four groups corresponding to the four regions separated by the cruciform trunk portion. Specifically, the plurality of branch portions are divided into the first group that is constituted of branch portions 12a extending in the direction of azimuthal angle 45°, the second group that is constituted of branch portions 12b extending in the direction of azimuthal angle 135°, the third group that is constituted of branch portions 12c extending in the direction of azimuthal angle 225°, and the fourth group that is constituted of branch portions 12d extending in the direction of azimuthal angle 315°.

In each of the first, second, third, and fourth groups, both the width of each of the plurality of branch portions (L) and the width of the space between any pair of adjacent branch portions (S) are in the range of not less than 1.5 μm and not more than 5.0 μm and are constant. L and S are preferably within the above range in terms of the stability of alignment of liquid crystal molecules and luminance. L/S is, for example, 3 μm/3 μm.

As described in for example Patent Documents 5 and 6, an electric field produced between adjacent branch portions (i.e., in a space portion) regulates the azimuth in which the liquid crystal molecules incline (the azimuthal angle component of the long axis of a liquid crystal molecule inclined by an electric field). This azimuth is parallel to the branch portions arranged in a stripe pattern and is identical with a direction toward the trunk portion. The azimuthal angle of the azimuth in which the liquid crystal molecules regulated by the first group branch portions 12a incline (first azimuth: arrow A) is about 225°. The azimuthal angle of the azimuth in which the liquid crystal molecules regulated by the second group branch portions 12b incline (second azimuth: arrow B) is about 315°. The azimuthal angle of the azimuth in which the liquid crystal molecules regulated by the third group branch portions 12c incline (third azimuth: arrow C) is about 45°. The azimuthal angle of the azimuth in which the liquid crystal molecules regulated by the fourth group branch portions 12d incline (fourth azimuth: arrow D) is about 135°. The four azimuths A to D are equal to the azimuths of the directors of the respective domains of the 4D structure which are formed in the presence of an applied voltage.

Due to the pixel electrode 12 which has the pattern of the above-described FB shape and the counter electrode 22 which has the cruciform opening 22a, the multidomain of 4D structure is formed by applying a sufficiently high voltage (e.g., white display voltage) across the liquid crystal layer 42. By combination of the pixel electrode 12 and the counter electrode 22 which can produce an electric field that forms the 4D structure in this way, not only the stability of the 4D structure but also the luminance can be improved as compared with the case where a 4D structure is formed by the effect of an independent one of the electrodes. The effect of improving the luminance will be described later. Note that, in the example described herein, one 4D structure is formed in one pixel. However, a plurality of 4D structures may be formed in one pixel by forming plural ones of the above-described electrode structure in one pixel.

The liquid crystal display device 100 further includes the alignment sustaining layers 34a and 34b. These alignment sustaining layers 34a and 34b function to regulate the pretilt azimuths of the liquid crystal molecules 42a of regions corresponding to respective ones of the four liquid crystal domains during the absence of an applied voltage across the liquid crystal layer 42. The pretilt azimuths are identical with azimuths A to D of the directors of the respective domains of the 4D structure obtained by the above-described electrode structure.

The alignment sustaining layers 34a and 34b are formed using a technology called “Polymer Sustained Alignment Technology” (sometimes referred to as “PSA technology”). Specific fabrication methods are described in Patent Documents 4 and 6. The entire disclosures of these documents are incorporated by reference in this specification. Here, a liquid crystal panel is fabricated by the same method as that described in Patent Document 6 (Example 5).

A liquid crystal display panel for the liquid crystal display device 100 is fabricated using a material that contains a photopolymerizable monomer in the proportion of not less than 0.1 mass % and not more than 0.5 mass % relative to a nematic liquid crystal material whose dielectric anisotropy is negative. The photopolymerizable monomer used herein may be an acrylate or dimethacrylate monomer which has a liquid crystal skeleton. The liquid crystal display panel includes substantially the same components as those of the liquid crystal display device 100 except that the liquid crystal material contains the monomer, that the alignment sustaining layers 34a and 34b are not formed, and that the polarizing plates 52a and 52b are not provided.

In the absence of an applied voltage across the liquid crystal layer, the liquid crystal molecules of the liquid crystal layer of this liquid crystal display panel (containing the above-described monomer) are vertically oriented by the anchoring force of the vertical alignment films 32a and 32b. This liquid crystal layer is irradiated with UV light (e.g., i-line at the wavelength of 365 nm, about 20 mW) of about 20 J/cm2 while 10 V, which is higher than the white display voltage (e.g., 4.5 V), is applied across the liquid crystal layer. As previously described, when a voltage is applied across the liquid crystal layer, four domains are formed in the liquid crystal layer by electric fields generated between the pixel electrode 12 which has a pattern of a FB shape and the counter electrode which has the cruciform opening 22a, such that the azimuthal angles of the directors of the four domains are 45°, 135°, 225°, and 315°. The UV irradiation causes polymerization of the monomer to produce a photopolymerized material. The photopolymerized material forms alignment sustaining layers 34a, 34b on the vertical alignment films 32a, 32b for fixing the above alignment of the liquid crystal molecules. A series of steps for photopolymerizing a monomer while applying a predetermined voltage in order to form alignment sustaining layers is sometimes referred to as “PSA process”. The voltage applied in the PSA process is typically, but is not limited to, a voltage which is not lower than the white voltage.

An example of the alignment sustaining layers 34a and 34b is described as to the structure with reference to FIG. 3. A SEM image shown in FIG. 3 is a result of a SEM observation of a surface of the alignment sustaining layer. Specifically, a sample of a liquid crystal display panel fabricated as described above was disassembled, and thereafter, the liquid crystal material was removed from the disassembled sample. A surface of the alignment sustaining layer of the resultant sample was then washed with a solvent and observed by SEM.

As seen from FIG. 3, the alignment sustaining layer contains particles of the photopolymerized material with the particle size of 50 nm or less. The photopolymerized material may not necessarily cover the entire surfaces of the alignment films. The surfaces of the alignment films may be partially exposed. The liquid crystal molecules aligned according to electric fields generated in the liquid crystal layer are fixed by the photopolymerized material, so that the alignment of the liquid crystal molecules is sustained even in the absence of an electric field. After the formation of the alignment sustaining layers over the vertical alignment films, the alignment sustaining layers regulate the pretilt directions of the liquid crystal molecules.

Note that the liquid crystal molecules 42a in the closest vicinity of the vertical alignment films 32a, 32b are under the strong anchoring effect and are therefore oriented vertical to the surfaces of the vertical alignment films 32a, 32b even in the presence of a voltage which is to be applied during light irradiation (e.g., about 10 V which is higher than the white display voltage). Thus, the inclination directions of the liquid crystal molecules 42a fixed by the alignment sustaining layers 34a and 34b formed over the vertical alignment films 32a, 32b are slightly inclined (1° to 5°) from the vertical direction (pretilt angle of 85° to 89°). The alignment of the liquid crystal molecules 42a fixed by the alignment sustaining layers 34a and 34b scarcely changes even when a voltage is applied.

As described above, the liquid crystal display device 100 uses the 4D structure and the linear polarization in combination. Therefore, the liquid crystal display device 100 has a higher contrast ratio and wider viewing angle characteristics than the conventional CPA mode liquid crystal display device which uses ¼-wave plates, and has a higher transmittance than the combination of the CPA mode and the linear polarization. Further, in the liquid crystal display device 100, the pretilt azimuths are regulated by the alignment sustaining layers 34a and 34b so as to conform to the 4D structure even in the absence of an applied voltage. Therefore, the alignment of the liquid crystal molecules is stable even at low gray scale levels as compared with a liquid crystal display device which employs the conventional FB-shaped pixel electrode or cruciform-slitted counter electrode or the combination of these electrodes.

Next, the reason that the luminance can be improved by positioning the cruciform opening 22a of the counter electrode 22 so as to extend over the cruciform skeleton portions 12h, 12v of the pixel electrode 12 which are in a fine stripe pattern is described.

First, the effects produced by the present invention are described with reference to FIG. 4 and FIG. 5. FIG. 4 shows a simulation result of the distribution of transmittance in a pixel in a white display state of the liquid crystal display device 100 of the present embodiment. FIG. 5 shows, for comparison purposes, a simulation result of the distribution of transmittance in a pixel in a white display state of a modification of the liquid crystal display device 100 in which the cruciform opening 22a is omitted from the counter electrode 22 (see, for example, Patent Documents 4 to 6; hereinafter, sometimes referred to as “comparative example liquid crystal display device”).

The pixel used in the simulation has the pixel pitch of 25.5 μm×40.0 μm (aspect ratio 1.6), which corresponds to 2.4-inch VGA. In the FB shape pattern of the pixel electrode 12 shown in FIG. 2, the width of each of the trunk portions 12h and 12v is 1.5 μm, the number of branch portions in each region is 10, and L/S=1.5 μm/1.5 μm.

As shown in FIG. 4, when the liquid crystal display device of the present embodiment is in a white display state, dark lines are clearly observed which intersect each other and which are parallel to the absorption axes of the polarizing plates placed in crossed Nicols (the absorption axes are perpendicular to the transmission axes). The other regions, i.e., the four liquid crystal domains, are in a substantially uniform white display state. As understood from this, in the liquid crystal display device of the present embodiment, the 4D structure is clearly formed, and almost all of the liquid crystal molecules in each domain are oriented in a predetermined director azimuth (an azimuth of 45° relative to the absorption axes of the polarizing plates).

On the other hand, as shown in FIG. 5, in the comparative example liquid crystal display device, the cruciform dark lines corresponding to the absorption axes of the polarizing plates are spreading and are bent like a windmill. As understood from this, although the 4D structure is formed even in the comparative example liquid crystal display device, the azimuths of the orientations of the liquid crystal molecules in each domain greatly vary.

As seen from the comparison between FIG. 4 and FIG. 5, the luminance in the white display state is higher in the liquid crystal display device of the present embodiment. This is because the orientations of the liquid crystal molecules in each domain are uniform (conform to the direction of the director) due to the cruciform slit 22a provided in the counter electrode 22.

Next, the optimum value for the width of the cruciform opening 22a is described with reference to FIG. 6 and FIG. 7. FIG. 6 shows graphs which illustrate the distributions of the azimuths of the orientations of the liquid crystal molecules for different widths of the opening 22a (widths of counter slit). For comparison purposes, the distribution in a structure with no opening is illustrated with the indication of “slit width 0 μm”. The pixel pitch is 25.5 μm×40.0 μm as described above.

In FIGS. 6(a) to 6(c), the abscissa axis represents the position along the vertical direction of the pixel and specifically represents the position on a line passing through the centers of two domains vertically adjacent to each other. Assuming that the horizontal slit of the cruciform opening 22a of the counter electrode 22 shown in FIG. 1(a) is identical with the X-axis and the vertical slit is identical with the Y-axis, the distributions of the azimuths of the orientations of the liquid crystal molecules of the domains formed in the second and third quadrants are herein shown. Note that the azimuthal angle of 135° is expressed as “−45°” which is an equivalent angle. FIG. 6(a) illustrates the distributions during application of 2.5 V across the liquid crystal layer (intermediate gray scale level display state). FIG. 6(b) illustrates the distributions during application of 4.5 V across the liquid crystal layer (white display state). FIG. 6(c) illustrates the distributions during application of a voltage higher than the white voltage (10 V).

First, as shown in FIG. 6(a), it is understood that a small number of liquid crystal molecules are oriented in the azimuth of 45° or −45° when the voltage applied across the liquid crystal layer is low. When the width of the slit is 6.0 μm, 7.0 μm, and 9.0 μm, only a small part of the liquid crystal molecules near an edge of the pixel electrode and near the slit are oriented in the azimuth of 45° or −45°.

Next, as shown in FIG. 6(b), it is understood that, when the slit width is 3.0 μm to 6.0 μm, liquid crystal molecules oriented in the azimuth of 45° or −45° exist in a wide range during application of the white display voltage (4.5 V).

As shown in FIG. 6(c), it is understood that, when the slit width is 3.0 μm to 6.0 μm, liquid crystal molecules oriented in the azimuth of 45° or −45° exist in a still wider range during application of 10 V which is higher than the white voltage. Even when the slit width is 7.0 μm or 9.0 μm, the liquid crystal molecules oriented in the azimuth of 45° or −45° exist in a wide range.

In a structure which does not have a slit, the proportion of liquid crystal molecules oriented in the azimuth of 45° or −45° is small in any of FIGS. 6(a) to 6(c). Especially in the case of FIG. 6(a) in which the applied voltage is low, liquid crystal molecules oriented in the azimuth of 45° or −45° rarely exist.

As described above, the alignment of the liquid crystal molecules in the respective domains of the 4D structure can be improved by providing the cruciform slit 22a in the counter electrode, even when the pixel pitch is relatively small.

As described above, by providing the cruciform opening 22a in the counter electrode 22, the proportion of liquid crystal molecules oriented in a predetermined azimuth (45° relative to the transmission axes of the polarizing plates) is increased, whereby the transmittance (display luminance) can be increased. However, as the width of the slit increases, a region in which the voltage applied across the liquid crystal layer is insufficient increases, so that the display luminance decreases. Now, the results of examinations as to the relationship between the slit width and the transmittance are described with reference to FIGS. 7(a) and 7(b).

In the graphs shown in FIGS. 7(a) and 7(b), the ordinate axis represents the transmittance (arbitrary unit), and the abscissa axis represents the slit width. Here, for comparison purposes, the relationship between the slit width and the transmittance in the conventional liquid crystal display device 90B which has the cruciform slit in the counter electrode (see FIG. 10) is shown together. FIG. 7(a) shows the relationship during application of 4.5 V across the liquid crystal layer (white display state). FIG. 7(b) shows the relationship during application of 10 V which is higher than the white voltage.

As seen from FIGS. 7(a) and 7(b), in terms of transmittance, the optimum width of the slit is 5.0 μm, and the width of the slit is preferably in the range of 3 μm to 6 μm. The liquid crystal display device 100, which includes the pixel electrodes having the FB shape pattern of the present embodiment, has a higher transmittance than the conventional liquid crystal display device 90B.

Next, a transmission-reflection combination type (or “transflective type”) liquid crystal display device 200, which is another embodiment of the present invention, is described with reference to FIG. 8. In the liquid crystal display device 200, each pixel includes two subpixel regions. One of the subpixel regions is a transmission subpixel region for display in the transmission mode, and the other is a reflection subpixel region for display in the reflection mode. FIG. 8(a) is a schematic plan view of one pixel of the liquid crystal display device 200. FIG. 8(b) is a schematic cross-sectional view taken along line 8B-8B′ of FIG. 8(a). Note that components which are common among the liquid crystal display device 200 and the liquid crystal display device 100 shown in FIG. 1 are indicated by the common reference numerals, and the description thereof is herein omitted.

As shown in FIG. 8(a), the pixel electrode 12 of the liquid crystal display device 200 includes two subpixel electrodes 12a and 12b which are aligned in a line along a column direction (vertical direction). The subpixel electrode 12a is a transparent electrode formed of, for example, an ITO film. The subpixel electrode 12b is a reflection electrode formed of, for example, an Al film.

The subpixel electrodes 12a and 12b each have a FB shape pattern. The counter electrode 22 which opposes the subpixel electrodes 12a and 12b via the liquid crystal layer has a cruciform opening 22a at a position opposing the transparent subpixel electrode 12a and a cruciform opening 22b at a position opposing the reflection subpixel electrode 12b. The cruciform openings 22a and 22b are positioned so as to oppose the cruciform trunk portions of the subpixel electrode 12a and the subpixel electrode 12b, respectively.

Thus, for the reasons described above, when a predetermined voltage is applied across the liquid crystal layer 42, the above-described four liquid crystal domains are stably formed in each of a transmission subpixel region corresponding to the transparent subpixel electrode 12a and a reflection subpixel region corresponding to the reflection subpixel electrode 12b.

The liquid crystal display device 200 has a retarder 62 in a region opposing the reflection subpixel electrode 12b as shown in FIG. 8(b). The retarder 62 is provided between the substrate 11 and the substrate 21 which oppose each other via the liquid crystal layer 42 and is therefore referred to as “internal retarder 62”. For example, the phase difference of the internal retarder 62 is a quarter wavelength. The internal retarder 62 is disposed such that its slow axis extends in a direction which forms an angle of 45° relative to the transmission axis of the polarizing plate 52b. The internal retarder 62 functions to convert linear polarization transmitted through the polarizing plate 52b to circular polarization. In this configuration, to equalize the optical path length for the light that contributes to the display in the reflection mode and the optical path length for the light that contributes to the display in the transmission mode, the thickness of the liquid crystal layer 42 in the reflection subpixel region is preferably half the thickness of the liquid crystal layer 42 in the transmission subpixel region. The thickness of the liquid crystal layer 42 may be adjusted by, for example, providing a transparent resin layer on a side of the internal retarder 62 which is closer to the substrate 21. The details of the internal retarder are disclosed in, for example, Japanese Laid-Open Patent Publication No. 2003-279957. The entire disclosures of this publication are incorporated by reference in the present specification.

Here, the configuration of one pixel which includes two or more subpixel regions has been described with an example of the transmission-reflection combination type liquid crystal display device 200, to which the present invention is however not limited. Even in transmission-type liquid crystal display devices and reflection-type liquid crystal display devices, a pixel may be divided into a plurality of subpixel regions.

### INDUSTRIAL APPLICABILITY

The present invention is applicable to liquid crystal display devices with relatively small pixel pitches, such as liquid crystal display devices for use in mobile phones.

1. A liquid crystal display device comprising a plurality of pixels and a pair of polarizing plates placed in crossed Nicols, the liquid crystal display device being configured to display an image in a normally black mode, wherein
each of the plurality of pixels includes
a liquid crystal layer including a nematic liquid crystal material whose dielectric anisotropy is negative,
a pixel electrode and a counter electrode opposing each other via the liquid crystal layer,
a pair of vertical alignment films respectively interposed between the pixel electrode and the liquid crystal layer and between the counter electrode and the liquid crystal layer, and
a pair of alignment sustaining layers formed by a photopolymerized material on respective surfaces of the pair of alignment films which are closer to the liquid crystal layer,
the pixel electrode has at least one cruciform trunk portion which is positioned so as to coincide with polarization axes of the pair of polarizing plates and a plurality of branch portions extending from the at least one cruciform trunk portion in a direction of approximately 45°,
the counter electrode has at least one cruciform opening which is positioned so as to oppose the at least one cruciform trunk portion,
when a predetermined voltage is applied across the liquid crystal layer, four liquid crystal domains are formed in the liquid crystal layer, azimuths of four directors that are representative of orientations of liquid crystal molecules included in the four liquid crystal domains being different from one another, and each of the azimuths of the four directors being generally parallel to any of the plurality of branch portions, and
when no voltage is applied across the liquid crystal layer, a pretilt azimuth of a liquid crystal molecule included in a region corresponding to each of the four liquid crystal domains is regulated by the alignment sustaining layers.

2. The liquid crystal display device of claim 1, wherein a width of the at least one cruciform opening is greater than a width of part of the trunk portion to which the opening opposes.

3. The liquid crystal display device of claim wherein
the four liquid crystal domains include a first liquid crystal domain where an azimuth of a director is a first azimuth, a second liquid crystal domain where an azimuth of a director is a second azimuth, a third liquid crystal domain where an azimuth of a director is a third azimuth, and a fourth liquid crystal domain where an azimuth of a director is a fourth azimuth, a difference between any two of the first azimuth, the second azimuth, the third azimuth, and the fourth azimuth being generally equal to an integral multiple of 90°, and
azimuths of directors of liquid crystal domains which are adjacent to each other via one of the at least one cruciform trunk portion are different by about 90°.

4. The liquid crystal display device of claim 1, wherein
the plurality of branch portions include
a first group of a plurality of first branch portions which are parallel to the first azimuth and which are arranged in a stripe pattern,
a second group of a plurality of second branch portions which are parallel to the second azimuth and which are arranged in a stripe pattern,
a third group of a plurality of third branch portions which are parallel to the third azimuth and which are arranged in a stripe pattern, and
a fourth group of a plurality of fourth branch portions which are parallel to the fourth azimuth and which are arranged in a stripe pattern, and
in each of the first, second, third, and fourth groups, both a width of each of the plurality of branch portions (L) and a width of a space between any pair of adjacent branch portions (S) are in the range of not less than 1.5 μm and not more than 5.0 μm.

5. The liquid crystal display device of claim 1, wherein
the pixel electrode includes a plurality of subpixel electrodes aligned in a line along a certain direction,
the at least one cruciform trunk portion includes a cruciform trunk portion of each of the plurality of subpixel electrodes,
the at least one cruciform opening of the counter electrode includes an opening which is positioned so as to oppose the cruciform trunk portion of each of the plurality of subpixel electrodes, and
when a predetermined voltage is applied across the liquid crystal layer, the four liquid crystal domains are formed in each of a plurality of subpixel regions corresponding to the plurality of subpixel electrodes on a one-to-one basis.

6. The liquid crystal display device of claim 5, wherein the plurality of subpixel regions include a transmission subpixel region which performs display in a transmission mode and a reflection subpixel region which performs display in a reflection mode.

7. The liquid crystal display device of claim 6, further comprising an internal retarder selectively provided only in a region corresponding to the reflection subpixel region.
